(19) United States
(12) Patent Application Publication
(10) Pub. No.: US 2002/0182580 A1
(43) Pub. Date: Dec. 5, 2002

(54) Extender for preserving porcine sperm cells

(76) Inventors: Jean-Gerard Saint-Ramon, L'aigle (FR); Serge Desherces, Vindelle (FR); Gustavo Decuadro-Hansen, Gauville (FR)

Correspondence Address: MORGAN & FINNEGAN, L.L.P., 345 Park Avenue, New York, NY, 10154-0053, US

(21) Appl. No.: 09/951,793

(22) Filed: Sep. 11, 2001

(30) Foreign Application Priority Data
Sep. 11, 2000 (FR) 0011524

(51) Int. Cl. A01N 1/02

(52) U.S. Cl. 435/2

(57) ABSTRACT

A concentrated liquid extender for preserving porcine sperm cells containing a preservative, a liquid antibiotic formulation, a carbohydrate, a buffer, a salt and an antioxidant.

### BACKGROUND OF THE INVENTION

1. Field of the Invention

The invention relates to an extender for preserving porcine sperm cells.

2. Description of the Prior Art

Good reproductive hygiene primarily involves preventive measures which limit risk factors. These measures relate to the premises, the operations linked to artificial insemination, farrow and the like. Such prevention makes it possible to contain, as much as possible, the presence and development of bacteria, which are responsible for contaminating the semen and the uterus with consequences which may seriously impair the level of performance of a pig production unit.

In the context of the preparation of semen, the extender constitutes an essential factor for preserving the fertilizing capacity of the doses of semen, through its biological and bacteriological quality.

A number of powdered porcine extenders are known. While they are convenient to transport and store, these powdered porcine extenders nevertheless have many disadvantages.

First of all, they cannot be sterilized.

Furthermore, the preparation of the porcine extender for use from a powder is long and tedious. For one liter of ready-to-use porcine extender, it is in fact usually necessary to dilute 50 to 60 g of powder and mixing and dissolving take about 10 minutes and stabilization about 15 minutes.

For storage and handling considerations, it is desirable to have an extender in concentrated form.

Compared with the powdered porcine extenders known to date, preparing a porcine extender in concentrated liquid form is extremely fast. However, no porcine extender in stable and concentrated liquid form is known as yet.

One object of the present invention is to provide a porcine extender in a stable concentrated liquid form which in particular does not exhibit a problem of yellowing.

Another object of the invention is to provide a porcine extender which can be sterilized.

A further object of the present invention is to provide a porcine extender having an antibiotic composition which is effective against the usual contaminants of boar semen.

Other objects and advantages will emerge on reading the description given below.

The porcine extenders known to date cannot solve the problems that arise.

Most porcine extenders known to date are provided in powdered form; however, it is practically impossible to ensure that a powder is sterile.

Moreover, in spite of a wide use of gentamicin as an antibiotic for boar semen, there can be substantial contamination after three days of storage.

No porcine extenders are known as yet which are both in concentrated liquid form and stable.

The extender of the invention meets the objectives defined and solves the above problems.

### SUMMARY OF THE INVENTION

The invention provides a liquid and concentrated extender that contains a preservative, a liquid antibiotic formulation, a carbohydrate, a buffer, a salt and an antioxidant.

The preservative is advantageously chosen from the group consisting of molecules on which a phosphatidic acid is grafted to constitute a phospholipid which is a compound of the cell membranes. The preservatives of the invention comprise, for example, cyclohexanehexols, such as inositol, and choline, ethanolamine and serine. Inositol is a preservative which is particularly preferred.

The liquid antibiotic is advantageously chosen from the group composed of enrofloxacin, lincomycin and spectinomycin. Enrofloxacin is a particularly preferred liquid antibiotic.

Enrofloxacin is 1-cyclopropyl-7-(4-ethyl-1-piperazinyl)-6-fluoro-1,4-dihydro-4-oxo-3-quinoline-carboxylic acid. It is marketed by Bayer under the name Baytril in the form of a 10% solution.

Lincomycin and spectinomycin are marketed by Upjohn under the names Lincocin and Trobicin.

The carbohydrate may be chosen from the group composed of nonreducing carbohydrates and reducing carbohydrates. Nonreducing carbohydrates include sucrose, trealose and raffinose, and reducing carbohydrates include glucose (anhydrous or monohydrate) and fructose.

Buffers include trimethylolmethylamine, this buffer being usually called Tris buffer or simply Tris, and trisodium citrate and ethylenediaminetetraacetic acid (EDTA). Note that EDTA can also serve as anti-agglutinating agent.

Salts include citric acid, sodium citrate, potassium chloride and sodium hydrogen carbonate (these examples are not limiting on the invention).

Antioxidants include amino acid derivatives such as peptides, for example reduced glutathione, cysteine, N-acetylcysteine and taurine.

The extender according to the invention is usually prepared in a concentrated form, also called “concentrate”. The liquid concentrate is then sterilized, for example, by membrane filtration, and diluted.

For use, a dilution is carried out, in general, a ten-fold dilution.

Ultrapure water, such as sterile and apyrogenic double-distilled water, is preferably used for the dilution.

The present invention provides a porcine extender in the “short” term preservation form (shelf life of 3 to 4 days) and in a “long” term preservation form (shelf life of 5 to 6 days). The “short” term preservation form is obtained by diluting the components in water. The “long” term preservation form is obtained by adding bovine albumin (also called BSA) to the “short” term preservation form.

An example of a formula of a concentrate for the extender of the invention (ten-fold concentrated) is given in Table I below:

TABLE I

| Compound | Concentration g/l of concentrate |
|---|---|
| Anhydrous glucose | 150-220, preferably 170-190 |
| Sucrose | 100-150, preferably 120-140 |
| Inositol | 60-70, preferably 65-68 |
| Tris | 30-50, preferably 38-42 |
| Trisodium citrate | 20-40, preferably 28-32 |
| Citric acid | 18-28, preferably 20-25 |
| KC1 | 5-10, preferably 7-8 |
| EDTA | 10-15, preferably 12-13 |
| NaHCO₃ | 10-15, preferably 12-13 |
| N-acetylcysteine | 1-3, preferably 1.8-2.2 |
| Antibiotic* | |

*Enrofloxacin, 10% solution, 100-200 μl and lincomycin/spectomycin (Linco-spectin from Upjohn), 2.5-3 ml of solution per 100 ml of concentrate.

A 1 liter concentrated solution (“short” term preservation form or concentrate, also called in the trade “medium long term extender”) is prepared and then divided into 10 vials of 100 ml. The antibiotic formulation is added to each of the 100 ml vials.

For the “long” term preservation form according to the invention (also called in the trade “long term extender”), BSA is added to the concentrate, preferably 8-15 g/l of BSA to 11 of concentrate (concentrated solution).

The solution, of the “short” or “long” term preservation form, is sterilized by filtration on two membranes, for example the first on a membrane of 0.45 μm and the second on a membrane of 0.22 μm.

There is claimed:

1. A liquid extender for preserving porcine sperm cells containing a preservative, a liquid antibiotic formulation, a carbohydrate, a buffer, a salt and an antioxidant.

2. The extender claimed in claim 1, wherein said preservative is chosen from the group consisting of molecules on which a phosphatidic acid is grafted to constitute a phospholipid which is a compound of the cell membranes.

3. The extender claimed in claim 2, wherein said preservative is chosen from the group consisting of cyclohexanehexols, choline, ethanolamine and serine.

4. The extender claimed in claim 3, wherein said preservative is a cyclohexanehexol.

5. The extender claimed in claim 4, wherein said cyclohexanehexol is inositol.

6. The extender claimed in claim 1, wherein said liquid antibiotic is chosen from the group composed of enrofloxacin, lincomycin and spectinomycin.

7. The extender claimed in claim 6, wherein said antibiotic is enrofloxacin.

8. The extender claimed in claim 1, wherein said carbohydrate is chosen from the group composed of nonreducing carbohydrates and reducing carbohydrates.

9. The extender claimed in claim 8, wherein said nonreducing carbohydrates are chosen from the group consisting of sucrose, trealose and raffinose.

10. The extender claimed in claim 8 or claim 9, wherein said reducing carbohydrates are chosen from the group consisting of glucose and fructose.

11. The extender claimed in claim 1, wherein said buffer is chosen from the group composed of trimethylolmethylamine, also called Tris buffer or Tris, trisodium citrate and ethylenediaminetetraacetic acid (EDTA).

12. The extender claimed in claim 1, wherein said salt is chosen from the group composed of citric acid, sodium citrate, potassium chloride and sodium hydrogen carbonate.

13. The extender claimed in claim 1, wherein said antioxidant is chosen from peptides and amino acid derivatives.

14. The extender claimed in claim 13, wherein said amino acid derivative is chosen from the group composed of peptides, taurine, cysteine and N-acetylcysteine.

15. The extender claimed in claim 1 additionally containing bovine albumin.

16. The extender claimed in claim 1 when it has undergone sterilization.

17. The extender claimed in claim 16, wherein said sterilization is carried out by membrane filtration.
